(19) United States
(12) Patent Application Publication
(10) Pub. No.: US 2006/0005782 A1
(43) Pub. Date: Jan. 12, 2006

(54) Pet carrier sweatshirt-known at the pet sweat

(76) Inventor: Joan C. Fugazzi, Oakdale, PA (US)

Correspondence Address: Joan C. Fugazzi, 300 Farmcrest Drive, Oakdale, PA, 15071, US

(21) Appl. No.: 11/147,731

(22) Filed: Jun. 8, 2005

Related U.S. Application Data
(60) Provisional application No. 60/584,757, filed on Jul. 1, 2004.

(51) Int. Cl. A01K 1/03

(52) U.S. Cl. 119/497

(57) ABSTRACT

Please acknowledge this patent for the pet carrier sweatshirt, that I call “Pet Sweat”. Because it is a tender loving way to hold and carry your pet many places, with the convenience of having two hands available to do what ever you wish. You can clean your yard, go shopping, and put your groceries away. Take out the trash. Talk on the phone, use your computer, get your mail, do your laundry, fold clothes, clean your house, you can go to work at some places that are allowed pets. As a florist designer, I am allowed to take my little Chihuahua dog with me to work and my dog will sit in the sweatshirt pocket while I make flower arrangements, clean the store, and wait on customers, answer the phone, and dust shelves. I believe many people now days are attached to their pets. This new invention will enable the comfort for a pet and pet owner that will be the first loving way to carry a pet in a fashionable mannerism with a variety of sweatshirt colors to match your jeans or any other outfit.

### CROSS REFERENCE

The application is based upon U.S. Provisional Application No. 60/584,757, filed Jul. 1, 2004.

The application is based upon a Design Patent Application No. 29/221,173, filed Jan. 11, 2005

The Trademark is a Chihuahua in a pocket. For Clothing Int. Class No. 025, No. 76/630028, filed Jan. 26, 2005

The Pet Carrier is a sweatshirt that has a large pocket on the front of the sweatshirt. The pocket is designed with sweatshirt material sewed inside the pocket. Canvas material is added around the sweatshirt material for support for a pet. The canvas material is only seen when you turn the Pet carrier inside out. The Pet Carrier is invented for the purpose to carry a dog or cat or any small pet weighing ten pounds or less. The pet owner can carry the pet and the pet is comfortable in the pocket. The convenience of this carrier permits the owner to carry the pet and leaves the hands free while the pet is being carried. In the pocket there is a ribbon, and the ribbon is sewed to the sweatshirt. The ribbon is approximately 24 inches long. The purpose of the ribbon is to tie the ribbon around the pets body as a safety feature. The pet carrier comes with no sleeves or long sleeves. Small sizes for girls, include fake pink or girly colors of fake fur is added as the neck collar and around the outside of the pocket for decoration. Lace is added on the sleeve cuff and around the neck as well for a girly look.

### Statement Regarding the Federally Sponsored Research or Development

No federally sponsored research and development

### Reference to Sequence Listing.

Does not apply

### BACKGROUUND OF THE INVENTION

Reference to Provisional Patent:

1. My dog wants to be carried, but I need 2 hands to do my work
2. The purpose and advantage is that both hands are free, and your dog or cat is comfortable.
3. Description—A pocket in a sweatshirt for dogs or cats or any small animals under ten pounds of weight .
4. Long Sleeve or short sleeve
5. Ramifications—The pet is comfortable with owner.
6. Tests—The pet has been carried around the house.
When using the Pet Carrier you must stay away from the stove or any hot fire area.
7. The Pet does not want to leave the Pet Carrier comfort.

### BRIEF SUMMARY OF THE INVENTION

The Pet Carrier is a convenient way to carry your pet anywhere and have two hands available to do whatever needed.

The Pet is comfortable and happy, and the owner has the confine of holding the pet Taking anywhere; shopping, activities, cleaning, work, convenience of taking the pet anywhere. If you have to carry luggage or baggages, or groceries, your pet is comfortable tucked safely away in the Pet carrier.

### BRIEF DISCRIPTION OF THE SEVERAL VIEWS OF THE DRAWING

FIG. 1. is a perspective view of the Pet Carrier Sweatshirt showing my new design in use.

FIG. 2. is a perspective view of the Pet Carrier Sweatshirt showing my new design.

FIG. 3 is a left side elevation view with the right side being a mirror image thereof,

FIG. 4 is a rear elevation view thereof

FIG. 5 is a top view thereof, and

FIG. 6. is a bottom view thereof

FIG. 7. is an inside out view of the Pet Carrier showing the front of my new design.

FIG. 8. is an inside out view of the Pet Carrier showing the rear of the new design.

FIG. 9. is a top inside out view thereof of the Pet Carrier Sweatshirt., and

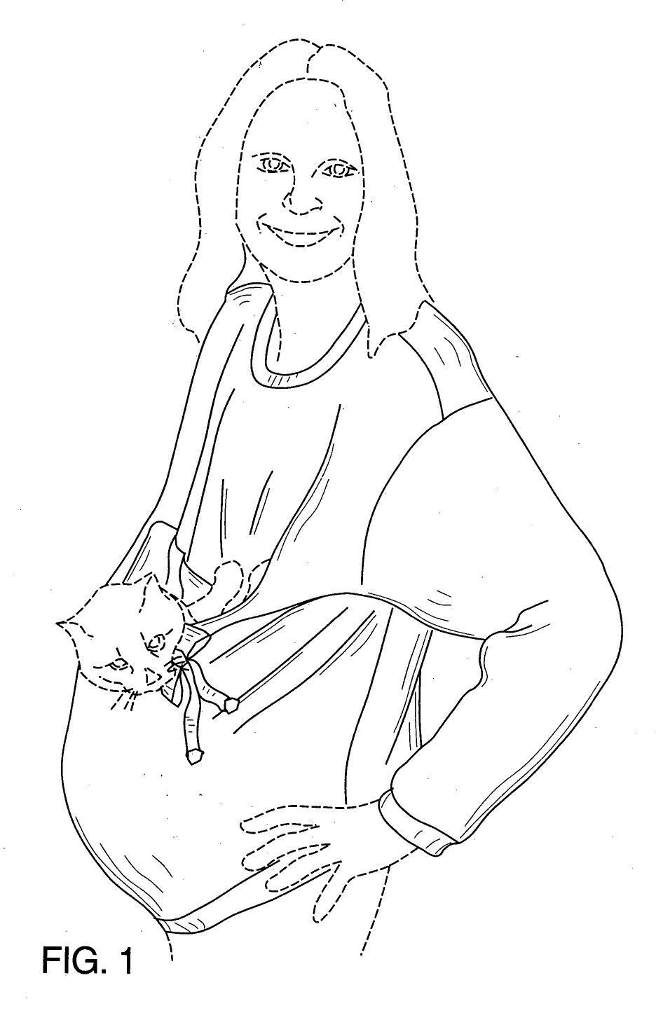

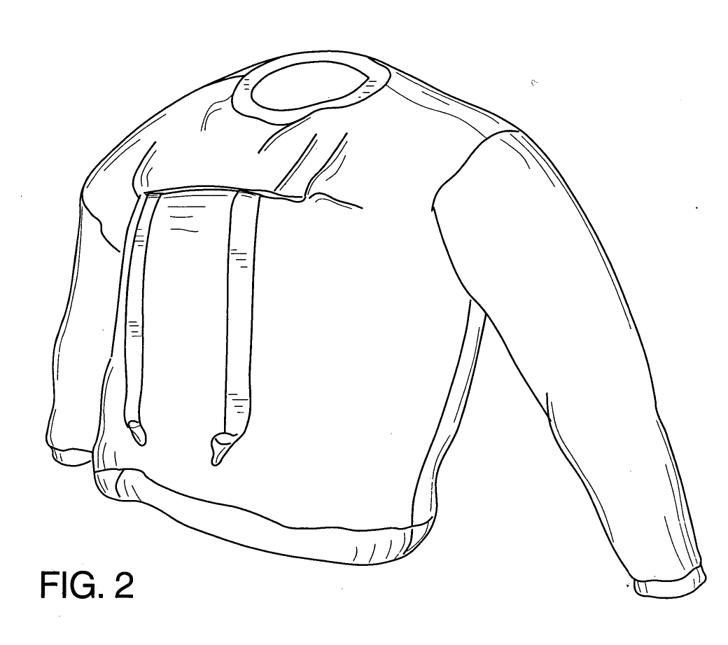

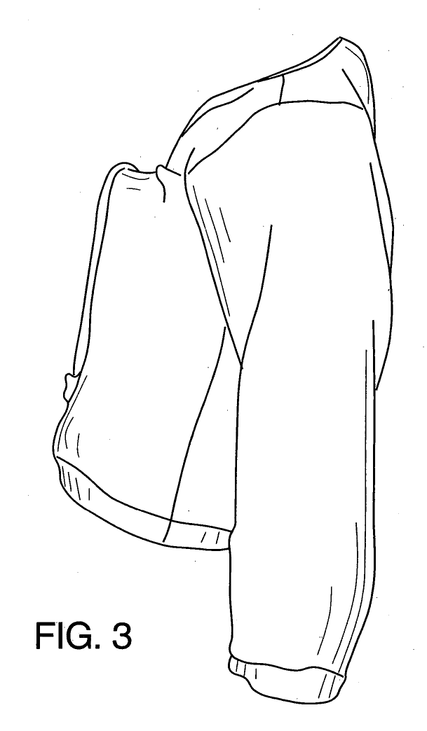

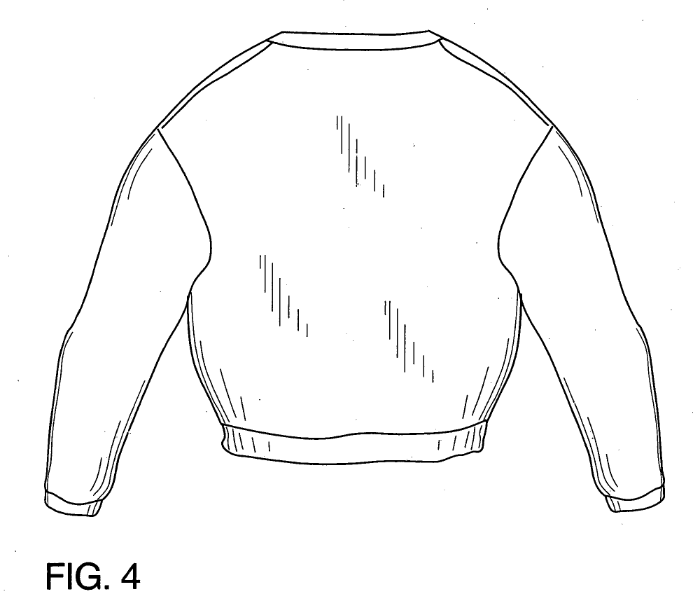

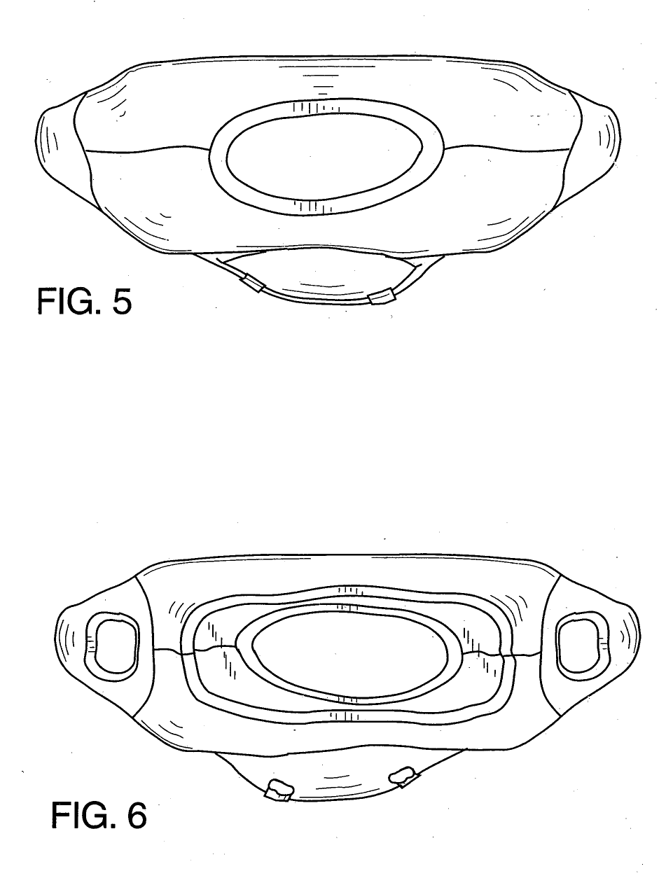

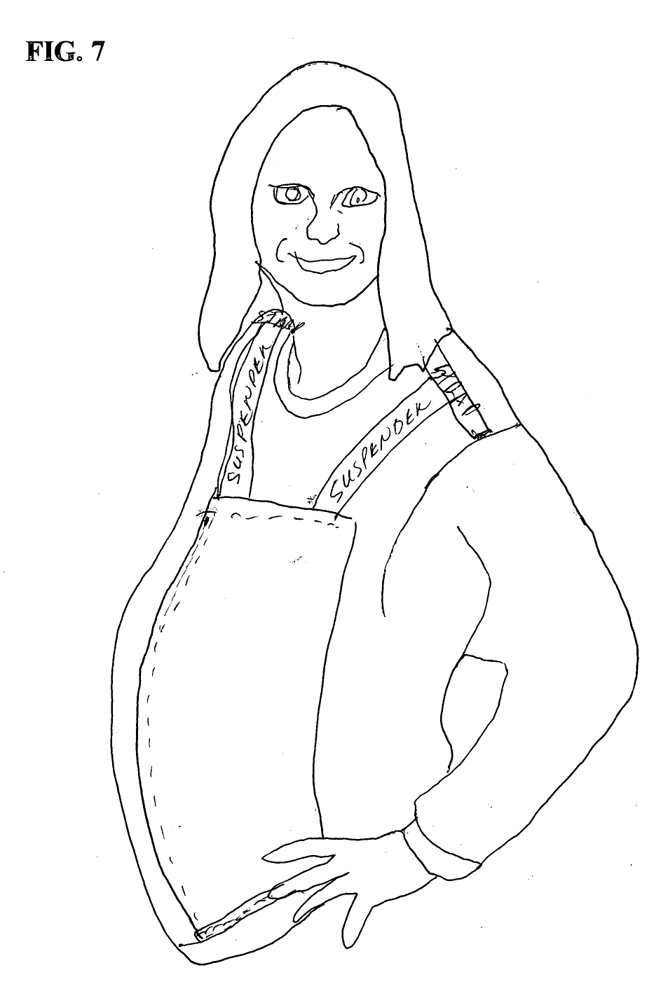

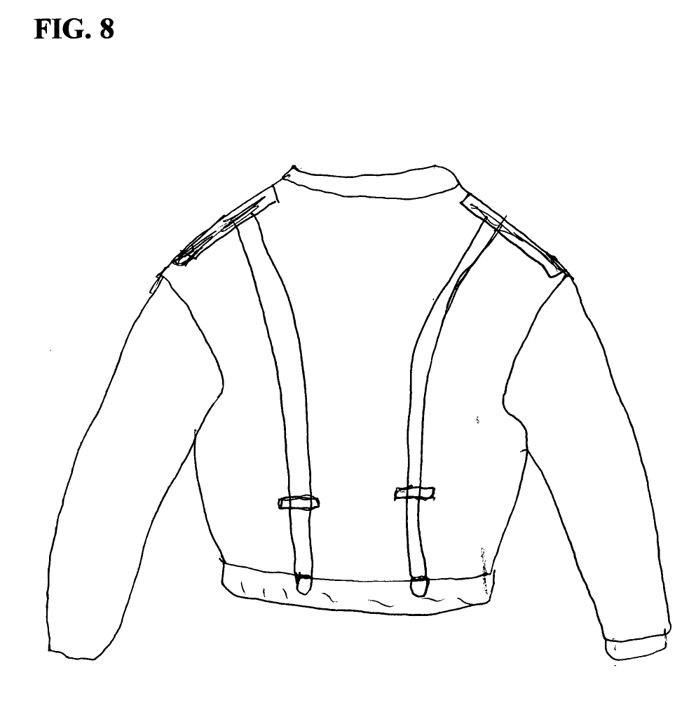

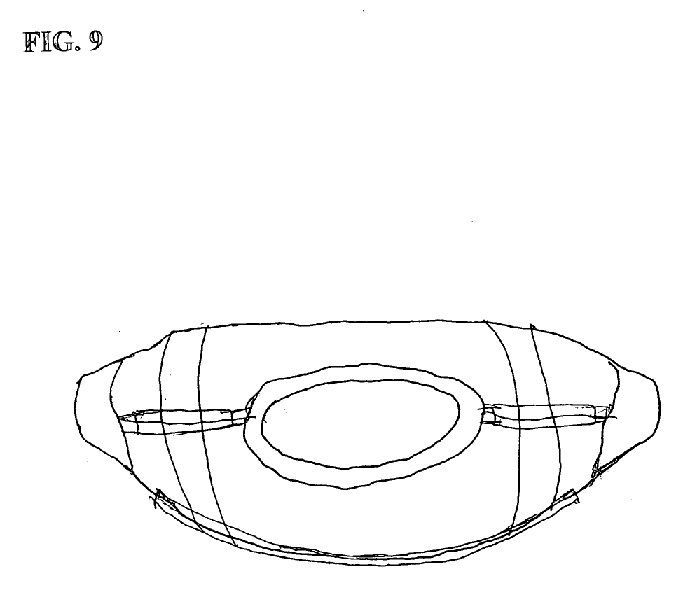

The broken line showing me wearing the Pet Carrier Sweatshirt and a pet in the pocket of the Pet Carrier Sweatshirt is for illustrative purposes only and form no part of the claimed design.

Some of these drawling are the same as the Design Patent.

### DETAILED DESCRIPTION OF THE INVENTION

The Pet Carrier Sweatshirt or I call the “Pet Sweat” is a convenient easy way to carry a pet in a big pocket. A pocket that is made with cozy and comfortable material as sweatshirt material.

[image]

[image]

[image]

[image]

[image]

[image]

[image]

[image]

[image]

[image]

[image]

[image]

[image]

[image]

1. What I claim as my invention is a unique, new, safe, convenient, and easy way to carry a small pet:
I feel because the popularity of small pets and the growing pet industry, it is very important to provide transportation for a pet. I believe my invention the pet carrier, that I call the “Pet Sweat” will be a popular way to carry a pet.
